(19) United States
(12) Patent Application Publication
(10) Pub. No.: US 2006/0112532 A1
(43) Pub. Date: Jun. 1, 2006

(54) Method for using shrinking net system

(76) Inventor: John Rexroad, Killingworth, CT (US)

Correspondence Address: ELLIS & VENABLE, PC, 101 NORTH FIRST AVE., SUITE 1875, PHOENIX, AZ, 85003, US

(21) Appl. No.: 10/998,492

(22) Filed: Nov. 29, 2004

(51) Int. Cl. B23P 19/04

(52) U.S. Cl. 29/433

(57) ABSTRACT

A method for using a shrinking net system to protect people from falling objects on the premises of a building undergoing construction or renovations is described. The shrinking net system is easy to install and tension. The shrinking net system includes a shrinking net and a means to attach the net to a building. An object with the potential of falling is wrapped in the shrinking net. After the shrinking net is wrapped around the hazardous object, a rope or metal rod is woven through the net and securely attached to the building. The net is then wetted and shrinks to tightly fit around the dangerous object. Because the net is made from a material that shrinks when wetted, it will not become loose around the object over time. Among other things, the shrinking net system allows construction crews and the public to be on the premises of a building under construction or renovations without being at risk for injury from falling objects.

### FIELD OF THE INVENTION

The present invention relates generally to nets, and particularly, to those found on buildings undergoing construction or renovations or on decaying structures such as bridges, building monuments, etc. The netting in the present invention is used to keep workers and the public safe while on or around the premises of a building undergoing construction, being renovated, or with unstable components, such as loose stones or roof tiles. In addition to using the netting on a building or structure, the netting can be used for handrails or barrier nets in an amusement park or as rack guards in an industrial conveyer facility. The mesh of the net is capable of being made taut around an object through the intermediary of a shrinkable net fiber which has a reduced length once it is moistened.

### BACKGROUND OF THE INVENTION

A building or structure that is unstable, under construction, or is being renovated is an inherently dangerous environment. The exterior of the building may include objects such as ornamentation, statues, cladding, etc., that become a potential falling hazard as they deteriorate over time and are in need of future repair. During construction or renovations, it is important to protect the crews working on the building, the public, and property around the building from falling objects. Moreover, it may be necessary for parts of the building to remain open to the public during the construction, renovations, or repairs. In such cases, it is a high priority to maintain a safe environment and protect members of the public and construction crews who are near the building premises.

One way to maintain a safe environment is to secure the loose or decaying objects with a net so that the net will contain any falling objects or debris. In the case of objects on the exterior or interior of a building, a net must be tightly wrapped around the object and securely attached to the building. The installation of the net around the object can be difficult because the net must be tensioned as it is installed. Additionally, over time the net can become loose creating an unsafe environment. Should debris become loose in the net, the net and debris must be removed to prevent a hazardous situation.

The present invention provides an improved way to install a net around a loose or decaying object while at the same time keeping the net taut over time. The present invention consists of a net constructed from fibers that shrink when moistened. The net is wrapped around the desired object and secured to the building by weaving a rope or metal bar through the net and attaching the rope or metal bar to the building with eyebolts, tie wraps, or lashing. The net is then moistened with water which causes it to shrink and fit tightly around the surface area of the object. Because the net does not have to be taut during installation, it is simple to secure the net around the desired object. Additionally, the net will not become loose over time once it is shrunk to fit around the object.

Currently, there are net systems that wrap around suspended objects to protect people on construction sites. However, each of the net systems suffers from several disadvantages. First, the prior art net systems are difficult to install because they must be tensioned during installation. To maintain tension in the net during installation is complicated and time consuming, and the net will not achieve maximum rigidity.

Second, the prior art net systems will become loose around the secured object over time. Since the net is not at its maximum tension when installed, the net is more likely to become loose. Additionally, traditional nets made of nylon are designed to stretch as load is applied. When this occurs, the net becomes loose, and it is necessary to remove the net to re-tension and re-secure the net and loose debris. Because the task of re-tensioning the net is time consuming and difficult, a construction crew may not be diligent in ensuring that the nets are properly tensioned; thus, creating a hazardous environment. This is a limitation of the prior art that the present invention overcomes.

Presently, there is no net system that is easy to install around the surface area of a loose or decaying object that also retains its tautness over time. For the foregoing reasons, a net that is easy to install and tension around the surface area of loose or decaying objects is desired.

### SUMMARY OF THE INVENTION

It is an object of the present invention to provide a shrinking net system that easily installs around the surface area of a loose or decaying object.
It is a further object of the present invention to provide a shrinking net system that may be tensioned subsequent to installation.
It is a further object of the present invention to provide a shrinking net system that remains taut over time.
It is a further object of the present invention to provide a shrinking net system that protects people from falling objects or debris on decaying structures, construction sites, or renovation sites.
It is a further object of the present invention to provide a shrinking net system to use as barriers in amusement parks.
It is a further object of the present invention to provide a shrinking net system to secure and protect objects from high winds.
It is a further object of the present invention to provide a shrinking net system that enhances the aesthetics of a building or structure under construction.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C §112, paragraph 6 to define the invention. To the contrary, if the provisions of 35 U.S.C §112, paragraph 6 are sought to be invoked to define the invention(s), the claims will specifically state the phrases “means for” or “step for” and a function, without also reciting in such phrases any structure, material, or act in support of the function.

Moreover, even if the provisions of 35 U.S.C §112, paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later developed equivalent structures, materials, or acts for performing the claimed function.

### BRIEF DESCRIPTION OF THE DRAWINGS

FIG. 1 shows a perspective view of the shrinking net system restraining an object attached to a wall and secured on the top and bottom.

FIG. 2 shows a perspective view of the shrinking net system wrapped around an object such as a column, before the net is shrunk

FIG. 3 shows a perspective view of the shrinking net system wrapped around an object such as a column, after the net is shrunk

FIG. 4 shows a section of the shrinking net system with woven nodal intersections.

FIG. 5 shows a section of the shrinking net system prior to shrinking with knotted nodal intersections and a rope woven through the net for securing to a surface.

FIG. 6 shows a section of the shrinking net system prior to shrinking with woven nodal intersections and a rope woven through the net for securing to a surface.

FIG. 7 shows a section of the shrinking net system with woven nodal intersections, a rope woven through the net for securing to a surface, and a plastic mesh on the underside of the net.

FIG. 8 shows a section of the shrinking net system with knotted nodal intersections and a rod woven through the top and the bottom of the net to secure the two adjoining net ends together.

FIG. 9 shows a section of the shrinking net system with woven nodal intersections and a rope woven through the top and bottom of the net to secure the two adjoining net ends together.

FIG. 10 shows a section of the shrinking net system with knotted nodal intersections and a sheath covered rope woven through the net for securing to a surface.

FIG. 11 shows a close up view of the shrinking net system at the knotted nodal intersections.

FIG. 12 shows a perspective view of the shrinking net system with knotted nodal intersections and in a diamond weave pattern with a securing member woven through the shrinking net.

FIG. 13 shows a section of the shrinking net system with knotted nodal intersections, a core of shrinking material, and an outer jacket of non-shrinking material.

FIG. 14 shows a section of the shrinking net system with a rope securing member connected to a cable with lashing to secure a plaster ceiling while maintaining clearance below.

FIG. 15 shows a section of the shrinking net system with a rope securing member connected to a cable with hooks to secure a plaster ceiling while maintaining clearance below.

FIG. 16 shows a fiberglass rod covered with rope sheathing.

FIG. 17 shows a section of a frame made up of four steel rods and four elbow fittings with the shrinking net woven in and out of the rod. The corner of the frame is lashed with shrinking cord to cover the elbow fittings.

FIG. 18 is the same as FIG. 17 with the elbow fittings exposed.

FIG. 19 shows an open detail of FIGS. 17 and 18.

FIG. 20 shows a section of the shrinking net system secured to a frame with the fiberglass rod of FIG. 16 supporting the shrinking net system on its vertical sides.

FIG. 21 shows a full view of the shrinking net system in FIG. 20.

FIG. 22 shows the shrinking net system with a fine mesh backing secured by weaving a shrinking rope in and out of the mesh. The shrinking net system is being tensioned with water.

FIG. 23 shows the shrinking net system wrapped around a decaying object.

FIG. 24 shows the shrinking net system wrapped around a decaying structure.

### DESCRIPTION OF PREFERRED EMBODIMENTS

As shown in FIG. 1, the preferred embodiment of the shrinking net system 100 generally includes a shrinking net 200, at least one securing member 300, and a surface 400. These components work together to secure objects 500 such as loose stones, bricks, ornamentation on building facades, etc. that pose a falling hazard. The shrinking net 200 is made of a braided rope having yarns which are formed from material which shrink along their elongated extent when wetted. This material is better referred to as water soluble shrinkable yarns which react to wetting by reduction in length, up to the point where strain is imposed on the yarns by, for example, an outside force, such as produced by reacting against a rigid securing member.

The Tables A and B below set forth the specific characteristics of the yarns which can comprise in whole or in part, the construction of the weft, warp, and border members. Kuraray Co., Ltd. sells these yarns under the trade name KURALON Type-T rope through the Kawashaima Trading Co., Ltd., 1-6-28, KYUTARO-MACHI, CHUO-KU, Osaka, Japan.

TABLE A
Properties of Water Soluble Kuralon Perlohke Yarn

In addition to the soluble property in hot water, water soluble Kuralon
perlohke yarn has the characteristic of remarkable high shrinkage
force in water.
A. Characteristics of water soluble Kuralon perlohke yarn.

| | |
|---|---|
| (1) | High shrinkage ratio in wet state. |
| | 40% at free tension |
| (2) | High shrinkage force in wet state. |
| | In case of 10's, the shrinkage force is about 30 gr. when |
| | both ends of yarn are fixed. |
| (3) | High elongation at break. |
| (4) | At wet state it shows elasticity like rubber. |
| (5) | Abrasion resistance at wet state is inferior to that of normal |
| | Kuralon perlohke yarn. |
| (6) | Tensile strength is about half of normal Kuralon perlohke yarn. |
| (7) | It dissolves in water at more than 80° C. |

B. Standard properties of Kuralon yarn.

| | | | |
|---|---|---|---|
| (1) | Description | 2005P20/1T | 2005P10/1T |
| (2) | Yarn Count | ECC 20's | ECC 10's |
| (3) | Dry | | |
| | Tensile Strength Kg | 0.60 | 1.70 |
| | Tenacity g/dr | 2.20 | 3.01 |
| | Elongation % | 15.0 | 17.0 |
| (4) | Wet | | |
| | Tensile Strength Kg | 0.25 | 0.49 |
| | Tenacity g/dr | 0.92 | 0.87 |
| | Elongation % | 102 | 108 |

In addition to the specific characteristics above in Table A, below listed in Table B are further characteristics illustrative of the yarn material used by the present invention.

TABLE B
Kuralon (PVA) High Shrinkage Cord

A. Initial Reactive Properties

| | |
|---|---|
| (1) | Fast shrinkage: |
| | The time required to reach 30% shrinkage is about 7 seconds |
| | in water at 20° C. and about 4 seconds in water at 30° C.. |
| (2) | High shrinkage: |
| | The shrinkage ration is about 75% in water at 20° C. |
| | and about 78% in water at 30° C.. |
| (3) | High shrinkage force: |
| | After absorbing water, a high shrinkage force is readily |
| | apparent. The shrinkage force is about 170 gram |
| | (0.1 gram/denier) in water at 30° C. after 10 seconds. |

B. Long Term Properties

| | |
|---|---|
| (1) | High strength after shrinkage: |
| | Strength is about 1 gram per denier after yarn is soaked |
| | for 16 hours. |
| (2) | Elasticity can be maintained for a long time. |

C. Standard Properties

| | | |
|---|---|---|
| (1) | Denier | 1786 |
| (2) | Unit Length (meter/gram) | 5.0 |
| (3) | Moisture Content (%) | 9.2 |
| (4) | Strength (Kg) | 3.88 |
| (5) | Tenacity (gram/dr) | 2.17 |
| (6) | Elongation at Break (%) | 26.0 |

In the embodiment shown in FIG. 13, the shrinking net 200 consists of two cords; an inner shrinking core 290 and an outer jacket 295 that is non-shrinking. The outer jacket 295 can be braided or twisted. The outer jacket 295 is braided, multifilament polypropylene, but could be any other material with the same characteristics. Alternatively, the shrinking net 200 could consist of one shrinking cord 290 with no outer jacket 295. However, the embodiment with two cords is preferred because the outer jacket 295 provides additional strength to the shrinking net 200, provides color options for the shrinking net 200, improves the wear of the shrinking net 200, and keeps the shrinking net 200 soft to the touch.

As shown in FIGS. 1, 5, and 6, the securing member 300 is woven through the shrinking net 200 and secured to the surface 400 from which the object 500 is suspended. In the preferred embodiment of the invention, the securing member 300 is a metal rod 310 or a rope 320. The securing member 300 can also be used to secure a non-shrinking net system to a surface 400. Fasteners 350, such as eyebolts 330, tie wraps 340, or lashings 360 are then used to attach the securing member 300 to the surface 400. The surface 400 can be a wall, a ceiling, the facade of a building, etc.

In the embodiment shown in FIG. 1, the shrinking net system 100 includes two securing members 300. The object 500 is covered with the shrinking net 200, and the securing members 300 are woven through the top and the bottom of the shrinking net 200. The fasteners 350 attach both securing members 300 to the surface 400 above and below the object 500. This embodiment is preferred when the object 500 is integrally attached to the surface 400 (i.e., an ornamental statue attachment that protrudes from the exterior of a building), and the shrinking net 200 cannot wrap around the entire object 500. By securing the object 500 to the surface 400 with two securing members 300 above and below the object 500, the shrinking net 200 will effectively prevent the object 500 from falling. Once the shrinking net 200 is properly installed, it is wetted and shrinks to tightly fit around the object 500.

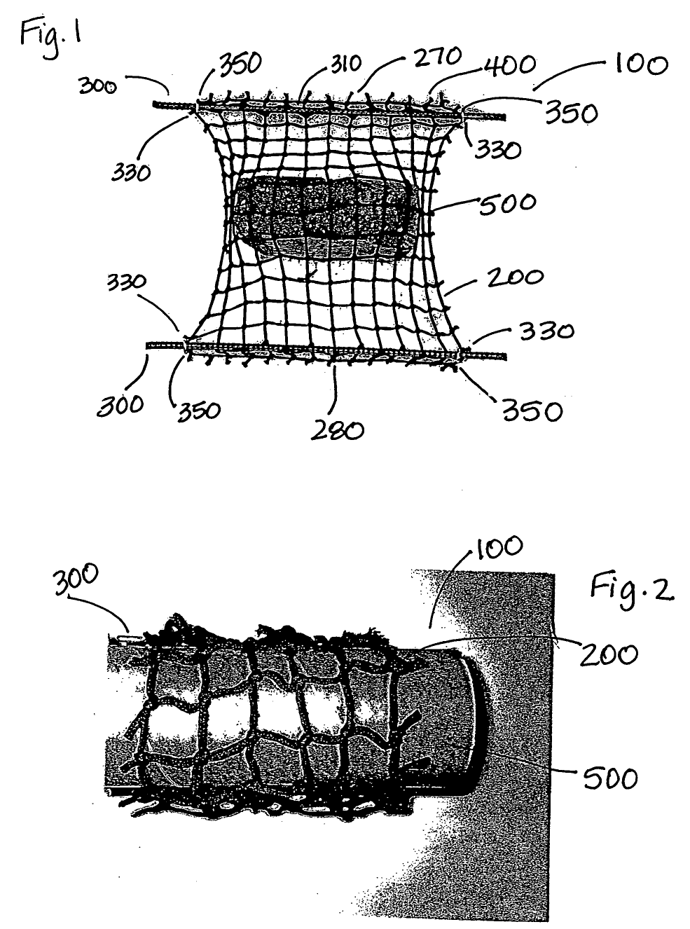

As seen in FIG. 2, the shrinking net 200 is secured around an object 500, such that slack exists between the shrinking net 200 and the object 500. In the embodiment in FIG. 2, the object 500 is freestanding and unobstructed around its circumference, such as a bridge support or a column. Once the shrinking net 200 has been wrapped around the object 500 and secured with the securing member 300, water is applied through a hose 600 or the like and the shrinking net 200 is caused to shrink to the point where it fits tightly around the object 500, as seen in FIG. 3. The shrinking net 200 fits around the object 500 much the same way shrink-wrap plastic fits around a box, book etc.

One advantage of using a shrinking net 200, which is capable of reducing its size, is that the shrinking net 200 can be secured around a potentially hazardous object 500 taking advantage of the slack. In other words, the shrinking net 200 does not have to be tensioned during the installation process because the slack in the shrinking net 200 is taken up by the subsequent wetting of the shrinking net 200.

FIGS. 8 and 9 show the shrinking net 200 with a securing member 300 woven through the top and bottom of the shrinking net 200 to secure the two adjoining ends together. This method of securing the shrinking net 200 is necessary when the shrinking net 200 is wrapped around an object 500 as in FIGS. 2 and 3. In addition, the securing member 300 can be used to secure two adjoining ends together of a non-shrinking net.

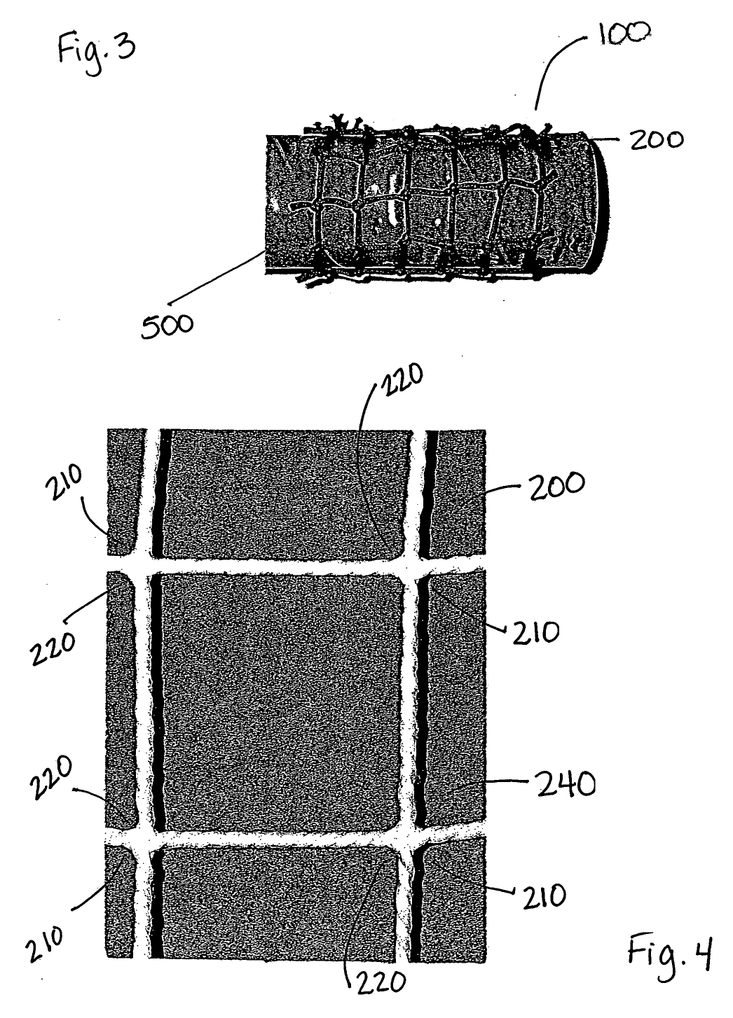

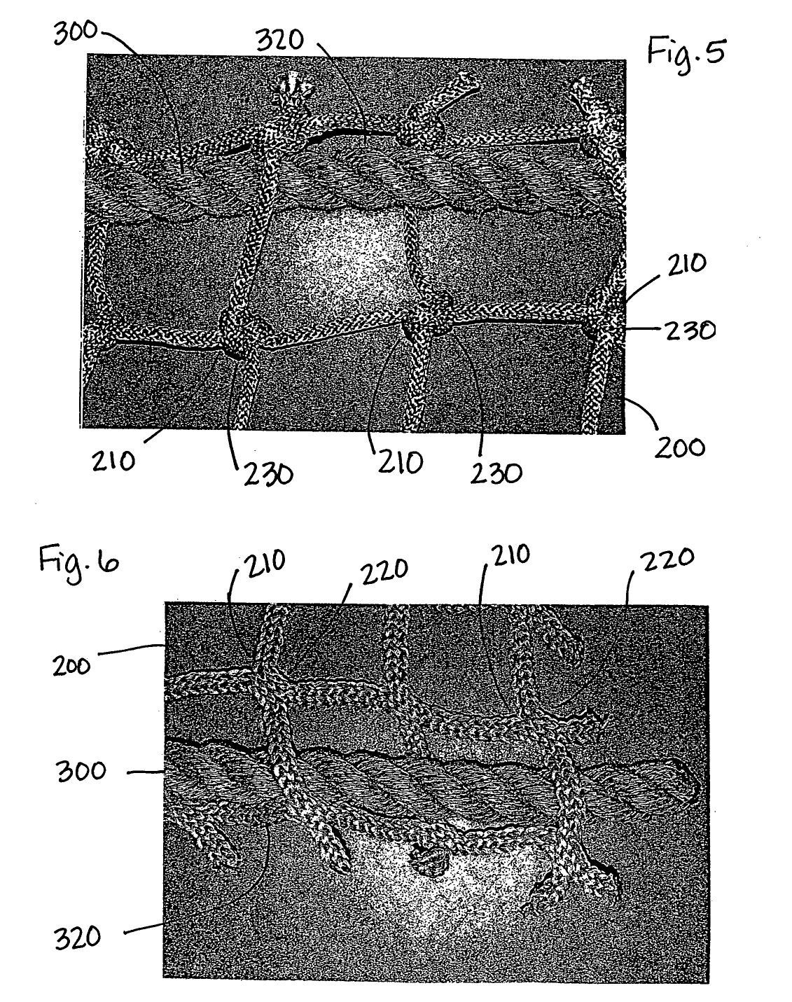

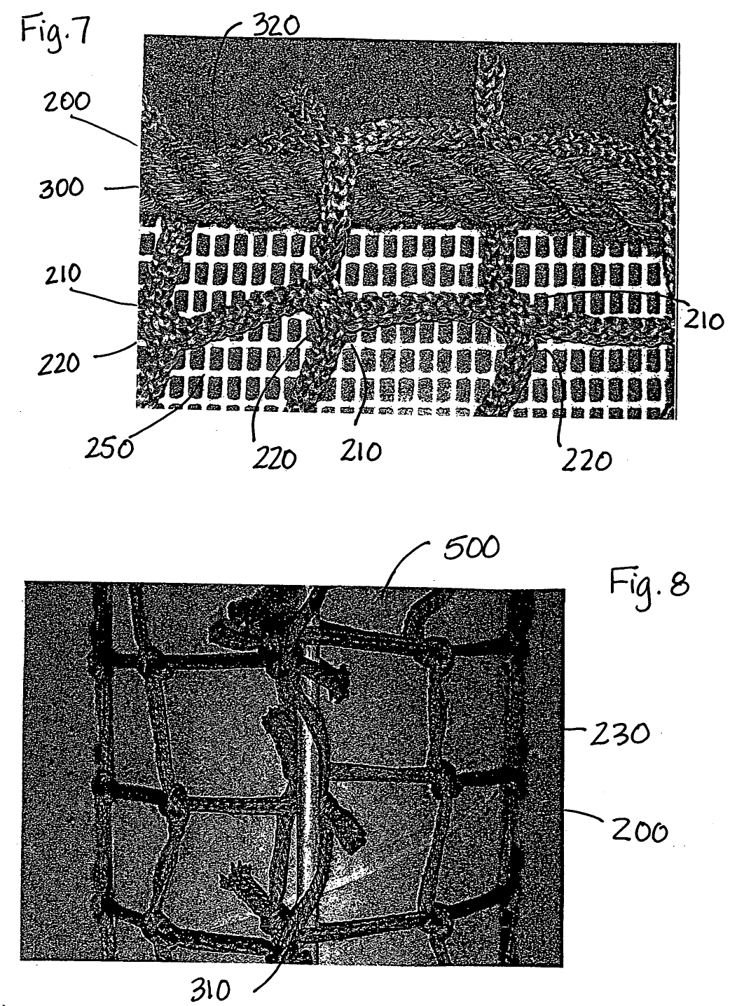

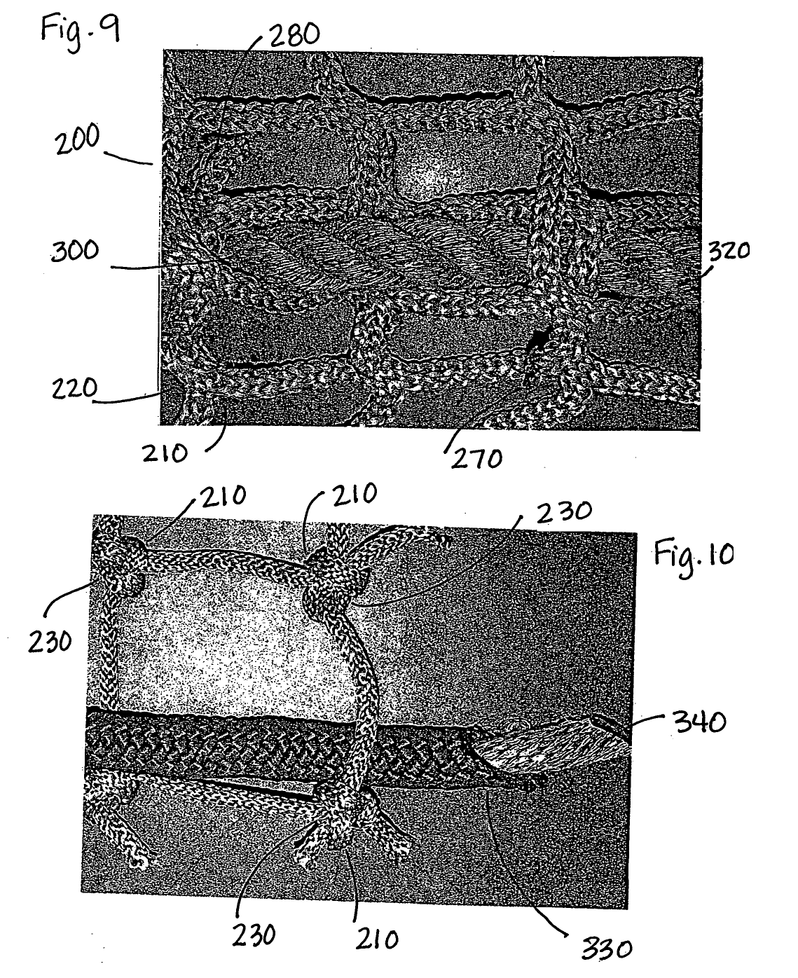

FIGS. 4, 6, and 9, show an embodiment of the shrinking net 200 prior to shrinking where the nodal points 210 are woven 220 through a twisting method. When the nodal points 210 of the shrinking net 200 are woven 220 through the twisting method, the shrinking net 200 is in a basket weave pattern 240. FIGS. 6 and 7 show the shrinking net 200 with woven 220 nodal points 210, and a securing member 300 woven through the shrinking net 200 on an end to be secured to a surface 400. FIG. 7 further shows an embodiment where a mesh 250 is placed under the shrinking net 200 to prevent small objects 500 from falling through the larger weave of the shrinking net 200. Once the shrinking net 200 is placed around the object 500 and secured with the securing member 300, it is wetted with water and shrinks to tightly hold the object 500 in place.

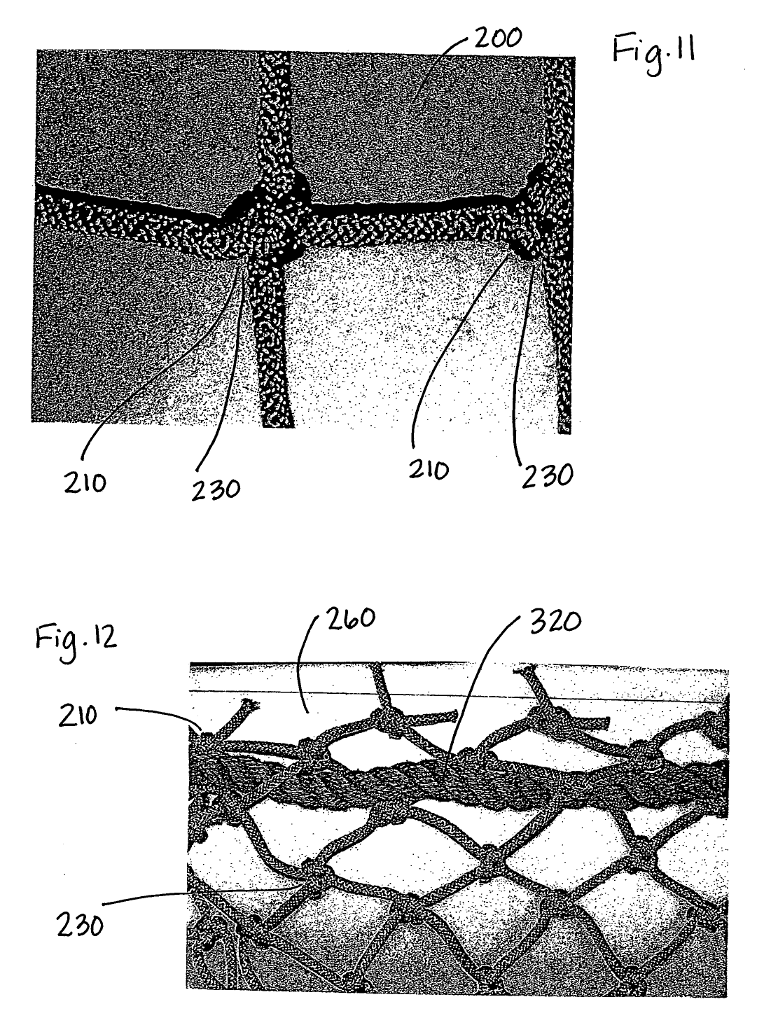

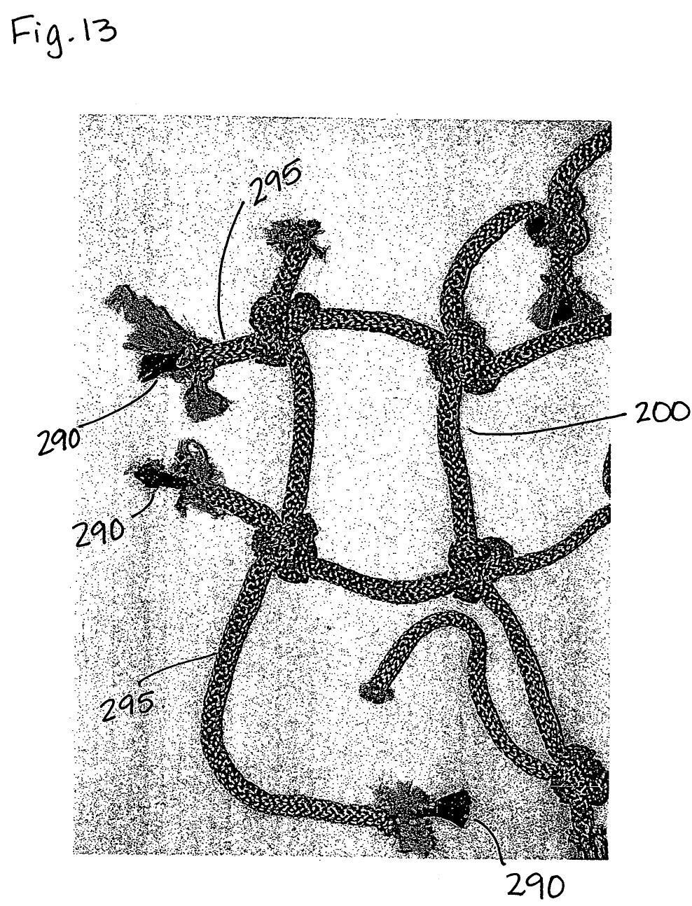

Shown in FIGS. 5, 10, 11 and 12, is the shrinking net 200 prior to shrinking with nodal points 210 that are knotted 230. The shrinking net 200 in this embodiment is in a diamond pattern 260 as shown in FIG. 12. FIGS. 5 and 10 show the shrinking net 200 with a securing member 300 woven through it on an end to be secured to a surface 400. The securing member 300 in FIG. 10 is a sheathed rope 330 with a shrinkable cord 340. Again, the shrinking net 200 is secured around an object 500, secured with the securing member 300, and wetted with water. Once the shrinking net 200 is wetted, it tightly fits around the object 500.

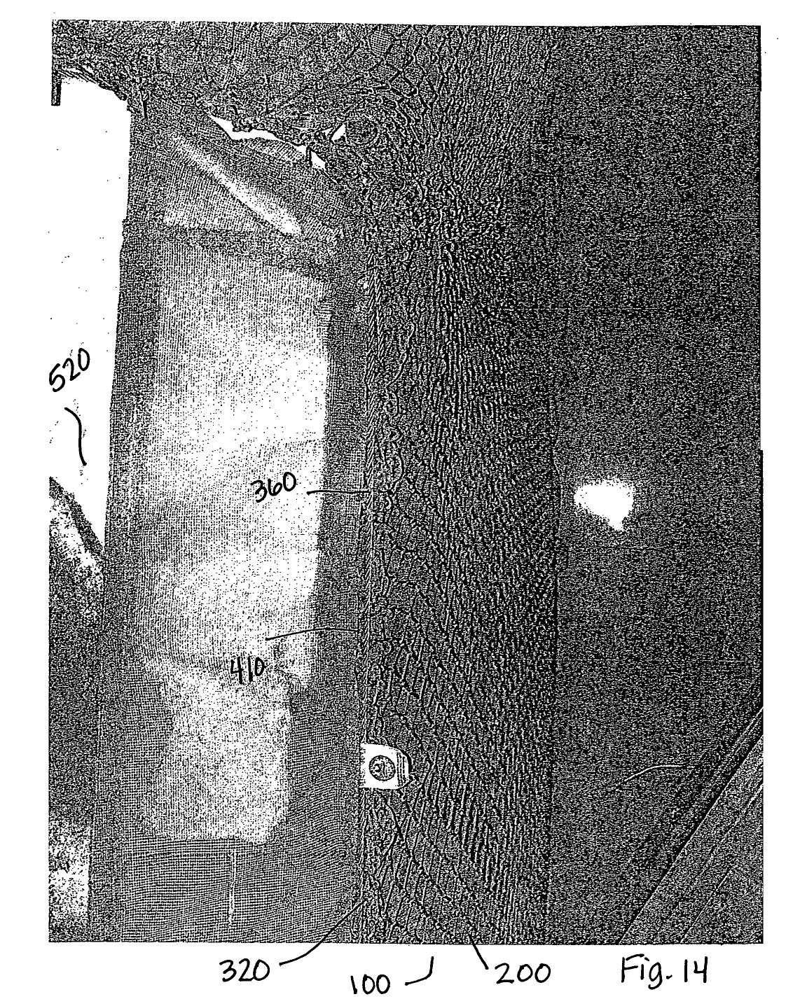

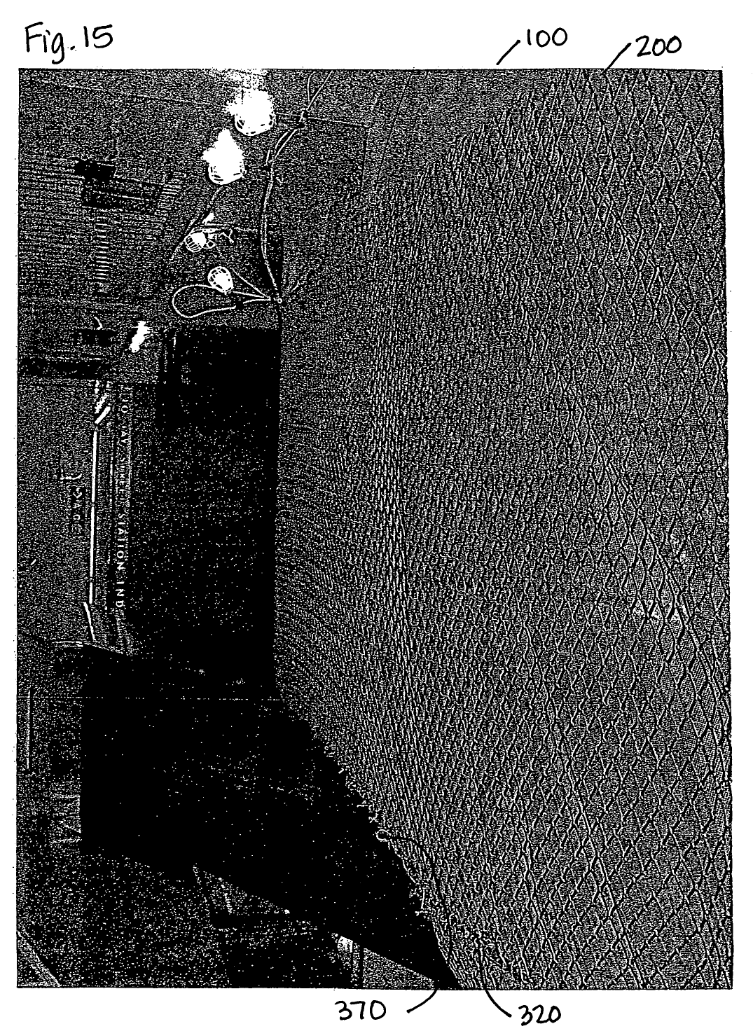

FIGS. 14 and 15 show the shrinking net system 100 securing a loose and decaying plaster ceiling 520. Woven through the knotted shrinking net 200 is a rope 320 acting as a securing member 300. The rope 320 is attached to a support cable 410 that is anchored to the surface 400 (i.e. the plaster ceiling 520). The rope 320 is attached to the support cable 410 with either lashing 360, as seen in FIG. 14, or with snap hooks 370, as seen in FIG. 15. In this embodiment, the loose plaster ceiling 520 is safely contained while still maintaining clearance below and allowing people to utilize the building. In addition, the taut shrinking net system 100 provides an improved aesthetic atmosphere in the building while under construction.

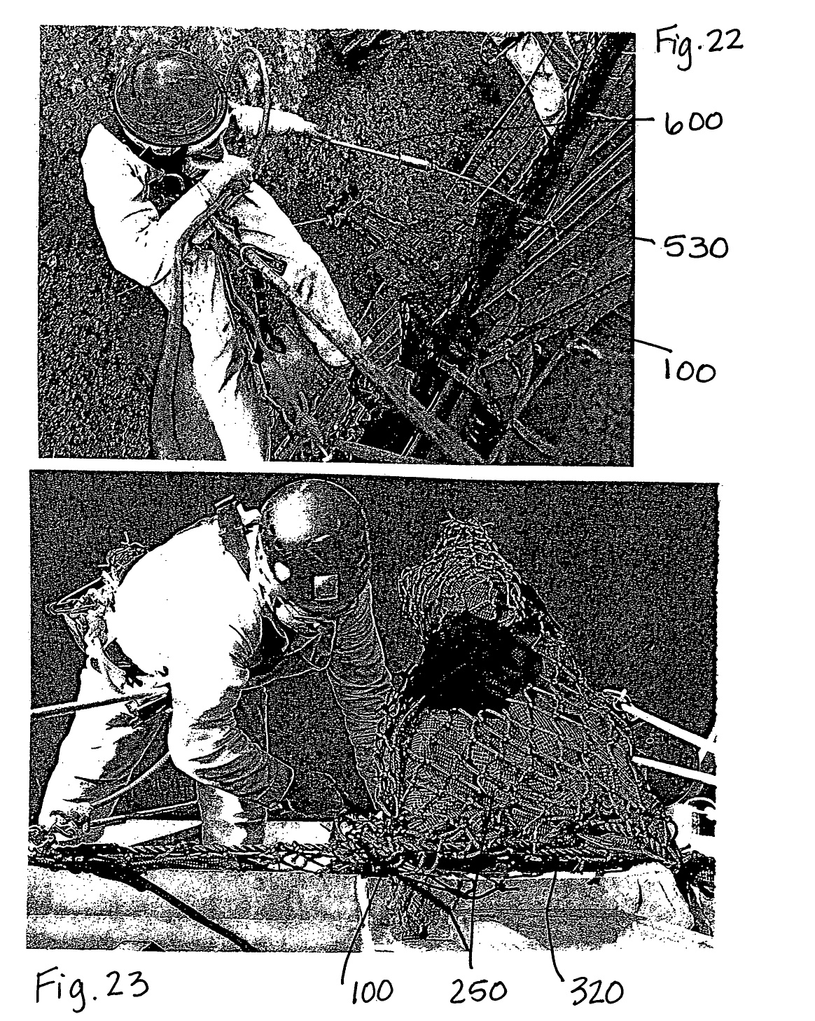

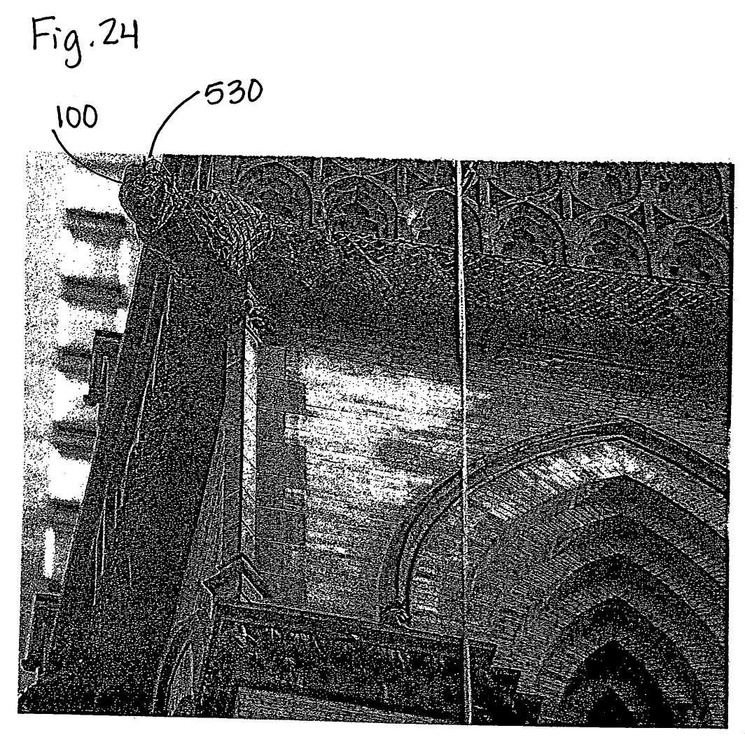

In FIGS. 22, 23, and 24, the shrinking net system 100 is securing decaying ornamental figures 530 on the outside of a building. The shrinking net 200 has a mesh 250 backing, and a rope 320 is woven through the shrinking net 200 as the securing member 300. In FIG. 22, the shrinking net 200 and the rope 320 are being tensioned with water through a hose 600. FIG. 24 shows a completed view of the shrinking net system 100 wrapped around the outside of a loose and decaying building.

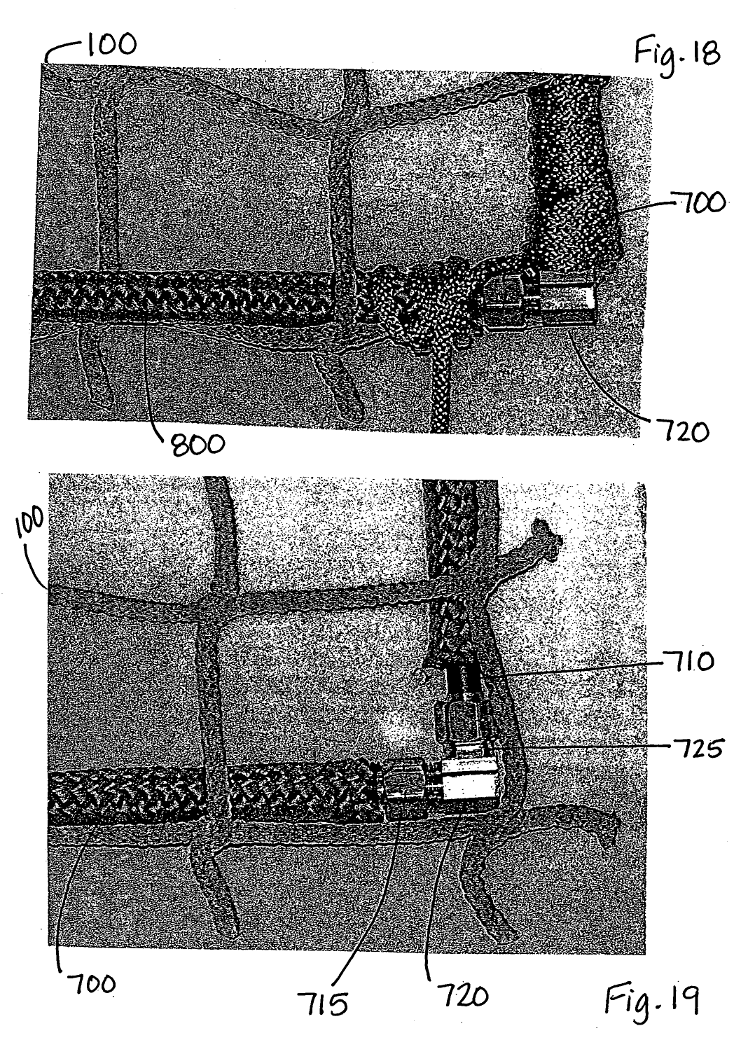

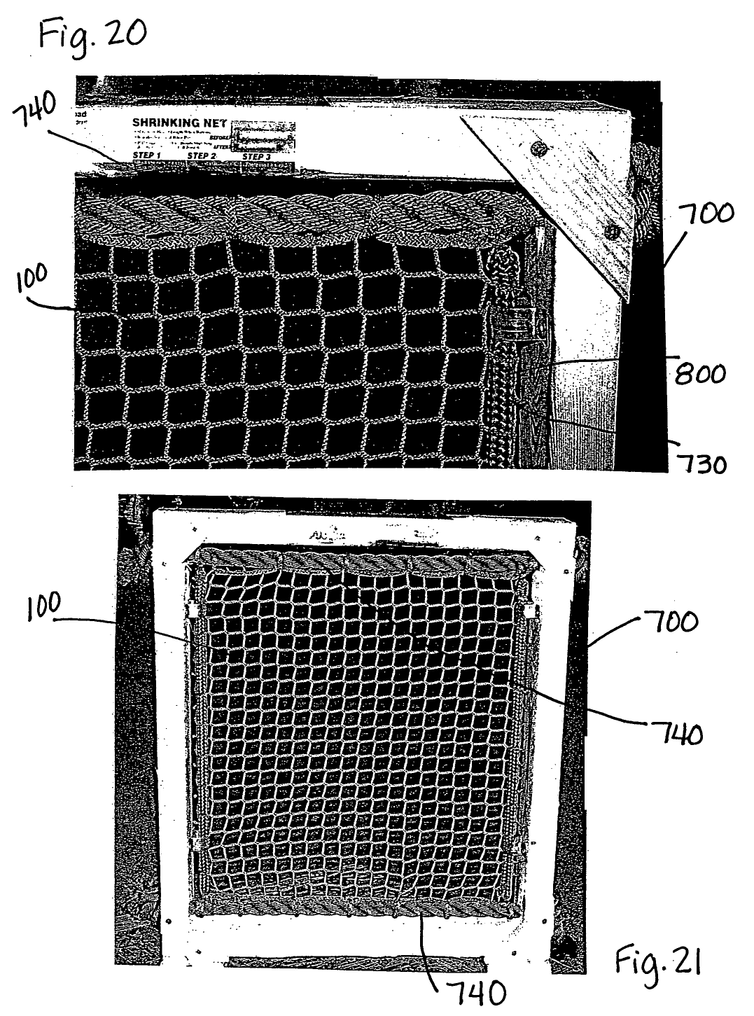

In an alternate embodiment of the invention, the shrinking net 200 is attached to a frame 700 as in FIGS. 17, 18, 19, 20, and 21. In FIGS. 17, 18, and 19, the shrinking net system 100 is attached to a frame 700 made of four steel rods 710 and four elbow fittings 720. The steel rods 710 are covered with a braided rope jacket 800 and the elbow fittings 720 are lashed with shrinking cord 810 to create an aesthetic design. FIG. 19 shows an open detail of the frame 700 pictured in FIGS. 17 and 18. The steel rods 710 are connected to the elbow fittings 720 with a nut 715 and a compression bushing 725.

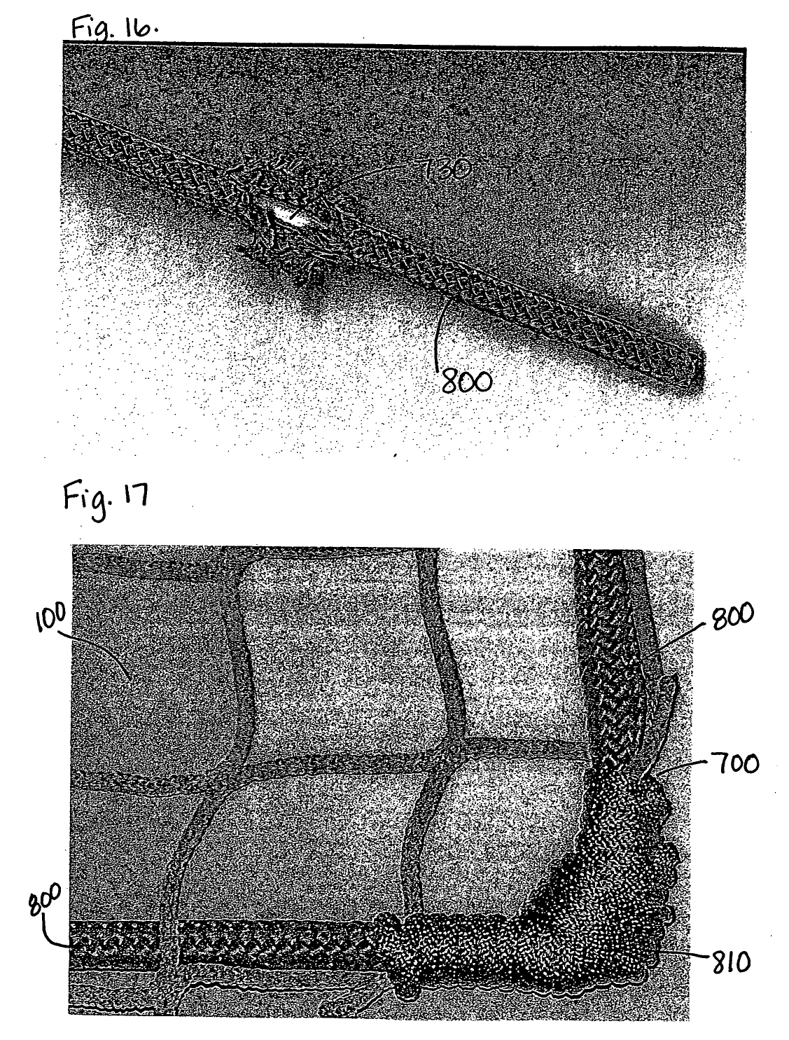

The frame 700 in FIGS. 20 and 21 is constructed from fiberglass rods 730 covered with a braided rope jacket 800 in the vertical direction, and twisted shrinking rope 740 in the horizontal direction. Alternatively, the shrinking net 200 could be supported on all four sides with fiberglass rods 730 and connectors 750 in the same way as in FIGS. 17 and 18. In FIG. 16 a detailed view of the fiberglass rod 730 is shown with the braided rope jacket 800 partially removed. The frames 700 in FIGS. 17, 18, and 21 allow the shrinking net to be used in amusement park settings and industrial facilities. The rigidity supplied by the steel rod 710 or the fiberglass rod 730 provides a safe and durable barrier.

The preferred embodiment of the invention is described above, in the Drawings, and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A method of restraining an object with a net comprising the steps of:
A. providing a net, wherein said net is constructed from a material that shrinks when wetted;
B. securing said net around an object, wherein said object is attached to a surface;
C. weaving a securing member through said net;
D. coupling said securing member to said surface; and
E. applying a liquid to said net such that said net shrinks around the surface area of said object such that said object is substantially restrained within said net.

2. The method of claim 1 further comprising the step of:
A. forming said net in a diamond pattern.

3. The method of claim 1 further comprising the step of:
A. forming said net in a basket weave pattern.

4. The method of claim 1 further comprising the step of:
A. forming a knot at a nodal point.

5. The method of claim 1 further comprising the step of:
A. twisting perpendicular cords at said nodal point.

6. The method of claim 1 further comprising the step of:
A. coupling said securing member to said surface with a tie wrap.

7. The method of claim 1 further comprising the step of:
A. coupling said securing member to said surface with an eyebolt.

8. The method of claim 1 further comprising the step of:
A. coupling said securing member to said surface with a lashing.

9. The method of claim 1 further comprising the step of:
A. weaving said securing member through said net, wherein said securing member is a rope.

10. The method of claim 1 further comprising the step of:
A. weaving said securing member through said net, wherein said securing member is a rod.

11. The method of claim 1 further comprising the step of:
A. securing said securing member to said surface, wherein said surface is an exterior facade of a building.

12. The method of claim 1 further comprising the step of:
A. securing said securing member to said surface, wherein said surface is a ceiling.

13. A method of restraining an object with a net comprising the steps of:
A. providing a net, wherein said net is constructed from a material that shrinks when wetted;
B. securing said net around an object, wherein said object is attached to a surface;
C. folding said net such that said net overlaps;
D. weaving a securing member through said net such that said net is connected;
E. coupling said securing member to said surface; and
F. applying a liquid to said net such that said net shrinks around the surface area of said object such that said object is substantially restrained within said net.

14. The method of claim 13 further comprising the step of:
A. forming said net in a diamond pattern.

15. The method of claim 13 further comprising the step of:
A. forming said net in a basket weave pattern.

16. The method of claim 13 further comprising the step of:
A. forming a knot at a nodal point.

17. The method of claim 13 further comprising the step of:
A. twisting perpendicular cords at said nodal point.

18. The method of claim 13 further comprising the step of:
A. coupling said securing member to said surface with a tie wrap.

19. The method of claim 13 further comprising the step of:
A. coupling said securing member to said surface with an eyebolt.

20. The method of claim 13 further comprising the step of:
A. coupling said member to said surface with a lashing.

21. The method of claim 13 further comprising the step of:
A. weaving said securing member through said net, wherein said securing member is a rope.

22. The method of claim 13 further comprising the step of:
A. weaving said securing member through said net, wherein said securing member is a rod.

23. The method of claim 13 further comprising the step of:
A. securing said securing member to said surface, wherein said surface is an exterior facade of a building.

24. The method of claim 13 further comprising the step of:
A. securing said securing member to said surface, wherein said surface is a ceiling.

25. A method of restraining an object with a net comprising the steps of:
A. providing a net, wherein said net is constructed from a material that shrinks when wetted;
B. securing said net to a frame;
C. weaving a securing member through a perimeter of said net;
D. coupling said securing member to said frame; and
E. applying a liquid to said net such that said net shrinks to become taut within said frame.

26. The method of claim 25 further comprising the step of:
A. forming said net in a diamond pattern.

27. The method of claim 25 further comprising the step of:
A. forming said net in a basket weave pattern.

28. The method of claim 25 further comprising the step of:
A. forming a knot at a nodal point.

29. The method of claim 25 further comprising the step of:
A. twisting perpendicular cords at said nodal point.

30. The method of claim 25 further comprising the step of:
A. coupling said securing member to said frame with a tie wrap.

31. The method of claim 25 further comprising the step of:
A. coupling said securing member to said frame with an eyebolt.

32. The method of claim 25 further comprising the step of:
A. coupling said securing member to said frame with a lashing.

33. The method of claim 25 further comprising the step of:
A. weaving said securing member through said net, wherein said securing member is a rope.

34. The method of claim 25 further comprising the step of:
A. weaving said securing member through a vertical side of said net, wherein securing member is a fiberglass rod.

35. The method of claim 25 further comprising the step of:
A. weaving said securing member through said perimeter of said net, wherein said securing member is a fiberglass rod.

36. The method of claim 25 further comprising the step of:
A. weaving said securing member through said net, wherein said securing member is a steel rod.

37. The method of claim 36 further comprising the step of:
A. connecting said securing member with a compression bushing.

38. A method of restraining an object with a net comprising the steps of:
A. providing a net;
B. securing said net around an object, wherein said object is attached to a surface;
C. weaving a securing member through said net; and
D. coupling said securing member to said surface.

39. The method of claim 38 further comprising the step of:
A. coupling said securing member to said surface with a tie wrap.

40. The method of claim 38 further comprising the step of:
A. coupling said securing member to said surface with an eyebolt.

41. The method of claim 38 further comprising the step of:
A. coupling said securing member to said surface with a lashing.

42. The method of claim 38 further comprising the step of:
A. weaving said securing member through said net, wherein said securing member is a rope.

43. The method of claim 38 further comprising the step of:
A. weaving said securing member through said net, wherein said securing member is a rod.

44. The method of claim 38 further comprising the step of:
A. weaving said securing member through said net, wherein said securing member is a fiberglass rod.

45. The method of claim 38 further comprising the step of:
A. securing said securing member to said surface, wherein said surface is an exterior facade of a building.

46. The method of claim 38 further comprising the step of:
A. securing said securing member to said surface, wherein said surface is a ceiling.

47. A method of restraining an object with a net comprising the steps of:
A. providing a net;
B. securing said net around an object, wherein said object is attached to a surface;
C. folding said net such that said net overlaps;
D. weaving a securing member through said net such that said net is connected; and
E. coupling said securing member to said surface.

48. The method of claim 47 further comprising the step of:
A. coupling said securing member to said surface with a tie wrap.

49. The method of claim 47 further comprising the step of:
A coupling said securing member to said surface with an eyebolt.

50. The method of claim 47 further comprising the step of:
A. coupling said securing member to said surface with a lashing.

51. The method of claim 47 further comprising the step of:
A weaving said securing member through said net, wherein said securing member is a rope.

52. The method of claim 47 further comprising the step of:
A weaving said securing member through said net, wherein said securing member is a rod.

53. The method of claim 47 further comprising the step of:
A weaving said securing member through said net, wherein said securing member is a fiberglass rod.

54. The method of claim 47 further comprising the step of:
A. securing said securing member to said surface, wherein said surface is an exterior facade of a building.

55. The method of claim 47 further comprising the step of:
A. securing said securing member to said surface, wherein said surface is a ceiling.
